(19) United States
(12) Patent Application Publication
(10) Pub. No.: US 2012/0102273 A1
(43) Pub. Date: Apr. 26, 2012

(54) MEMORY AGENT TO ACCESS MEMORY BLADE AS PART OF THE CACHE COHERENCY DOMAIN

(76) Inventors: Jichuan Chang, Palo Alto, CA (US); Paranathan Partha, Palo Alto, CA (US); Kevin Lim, Palo Alto, MI (US)

(21) Appl. No.: 13/380,490

(22) PCT Filed: Jun. 29, 2009
(86) PCT No.: PCT/US2009/049038

§ 371 Date: Dec. 22, 2011

(51) Int. Cl. G06F 12/08

(52) U.S. Cl. 711/143; 711/118; 711/141; 711/E12.026

(57) ABSTRACT

A system and method is shown wherein a memory agent module to identify a memory command related to virtual memory pages associated with a memory blade and maintain and optimize cache coherency for such pages. The system and method also includes a memory module, operatively connected to the memory agent that includes a page cache used by the memory agent to manage the virtual memory page. Further, the system and method includes a transmission module to transmit the memory command to the memory blade, as well as data structures to facilitate the page migration between the compute blade's local memory and remote memory on the memory blade.

### BACKGROUND

Multi-core based computing may be used to solve a number of data intensive problems. Computers with multiple cores can be implemented as compute blades in a blade rack, a plurality of computers organized as one or more computing clusters, or some other suitable organization. These computers with multiple cores can be used within a data center, server farm, or some other suitable facility.

### BRIEF DESCRIPTION OF THE DRAWINGS

Some embodiments of the invention are described, by way of example, with respect to the following figures:

FIG. 1 is a diagram of a system, according to an example embodiment, illustrating a compute blade architecture that utilizes a memory agent.

FIG. 2 is a diagram of a system, according to an example embodiment, that utilizes a memory agent to manage the memory for a compute blade.

FIG. 3 is a diagram of memory agent logic architecture, according to an example embodiment, that is implemented as part of a memory agent.

FIG. 4 is a diagram of a system, according to an example embodiment, illustrating the migration of a remote memory page.

FIG. 5 is a diagram of a system, according to an example embodiment, illustrating the migration of a local memory page.

FIG. 6 is a block diagram of a computer system, according to an example embodiment, in the form of the compute blade used to implement a memory agent to process a memory command.

FIG. 7 is a block diagram of a computer system, according to an example embodiment, in the form of the compute blade used to implement a memory agent to maintain cache coherency.

FIG. 8 is a block diagram of a computer system, according to an example embodiment, in the form of the compute blade used to store evicted dirty data to a write back buffer.

FIG. 9 is a flow chart illustrating a method, according to an example embodiment, executed on a compute blade to process a memory command.

FIG. 10 is a flow chart illustrating a method, according to an example embodiment, executed on a compute blade to implement a memory agent to maintain cache coherency.

FIG. 11 is a flow chart illustrating a method, according to an example embodiment, executed on a compute blade to store data to a write back buffer.

FIG. 12 is a flow chart illustrating a method, according to an example embodiment, for initiating the boot up of a compute blade boot with memory agents.

FIG. 13 is a flowchart illustrating the execution of operation, according to an example embodiment, to conduct a capacity option selection.

FIG. 14 is a flow chart illustrating a method, according to an example embodiment, for page cache access.

FIG. 15 is a diagram of a vector, according to an example embodiment, for storing the generation bits and reference counter values as part of a page cache.

FIG. 16 is a flow chart illustrating a method, according to an example embodiment, used to facilitate page migration.

FIG. 17 is a diagram of a computer system, according to an example embodiment.

### DETAILED DESCRIPTION

Illustrated is a system and method for a compute blade architecture utilizing a memory agent to facilitate processor load/store based access to remote memory, and to optimize performance by selective executing local and remote virtual memory page swaps. A compute blade, as referenced herein, is a computer system with memory to read commands and data, and a processor to execute commands manipulating that data. Commands, as referenced herein, may be memory commands. In some example embodiments, the compute blade also includes a backing storage (e.g., the above referenced memory) to store the results. This backing storage may be located native to the compute blade or remote to the compute blade in a memory blade. As used herein, a remote memory agent is a memory agent. A virtual memory page or memory page is a fixed-length block of memory that is contiguous in both physical memory addressing and virtual memory addressing. This memory may be Static Random Access Memory (SRAM), Dynamic Random Access Memory (DRAM), or another Main Memory implementation (e.g., optically, magnetically or flash based memory). A local virtual memory page is a located on a compute blade, whereas a remote memory pages is access across a network and may reside on a memory blade.

In some example embodiments, a swapping regime is implemented wherein the accessing of a virtual memory page is tracked and swapping is based upon this tracking. As used herein, swapping includes migration. Tracking may include maintain a reference counter value for each virtual memory page, where the number of times the virtual memory page is accessed across a generation is recorded. In cases where a virtual memory page has a larger reference counter value associated with it as compared to another virtual memory page, the virtual memory page with the larger reference counter value is deemed to be a “hot page,” and will be less likely to be used in the swapping of a remote for a local virtual memory page. Virtual memory pages with a relatively low reference counter value as compared to another virtual memory page are deemed to be “cold pages.”

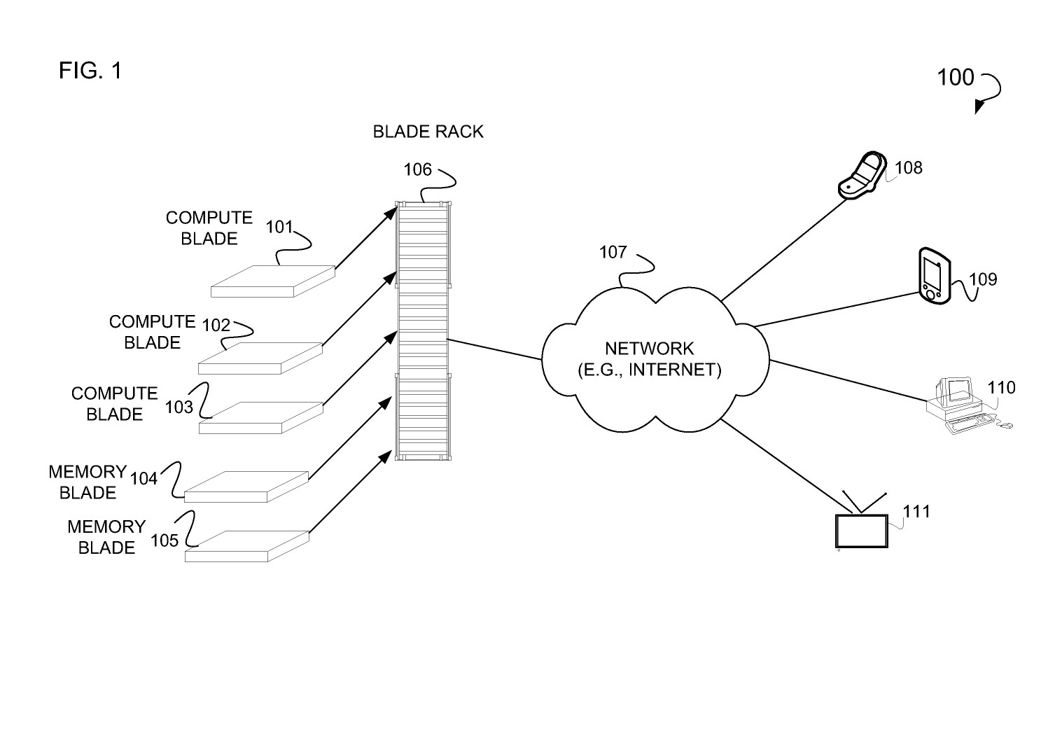

FIG. 1 is a diagram of an example system 100 illustrating a compute blade architecture that utilizes a memory agent. Shown are a compute blade 101, a compute blade 102, a compute blade 103, and a memory blade 104 and memory blade 105. Each of the compute blades and memory blades are positioned proximate to a blade rack 106. The compute blades 101-103 are operatively connected to the network 107 via a logical or physical connection. The network 107 may be an internet, an intranet, a Wide Area Network (WAN), a Local Area Network (LAN), or some other network and suitable topology associated with the network. In some example embodiments, operatively connected to the network 107 is a plurality of devices including a cell phone 106, a Personal Digital Assistant (PDA) 107, a computer system 108 and a television or monitor 109. In some example embodiments, the compute blades 101-103 communicate with the plurality of devices via the network 107.

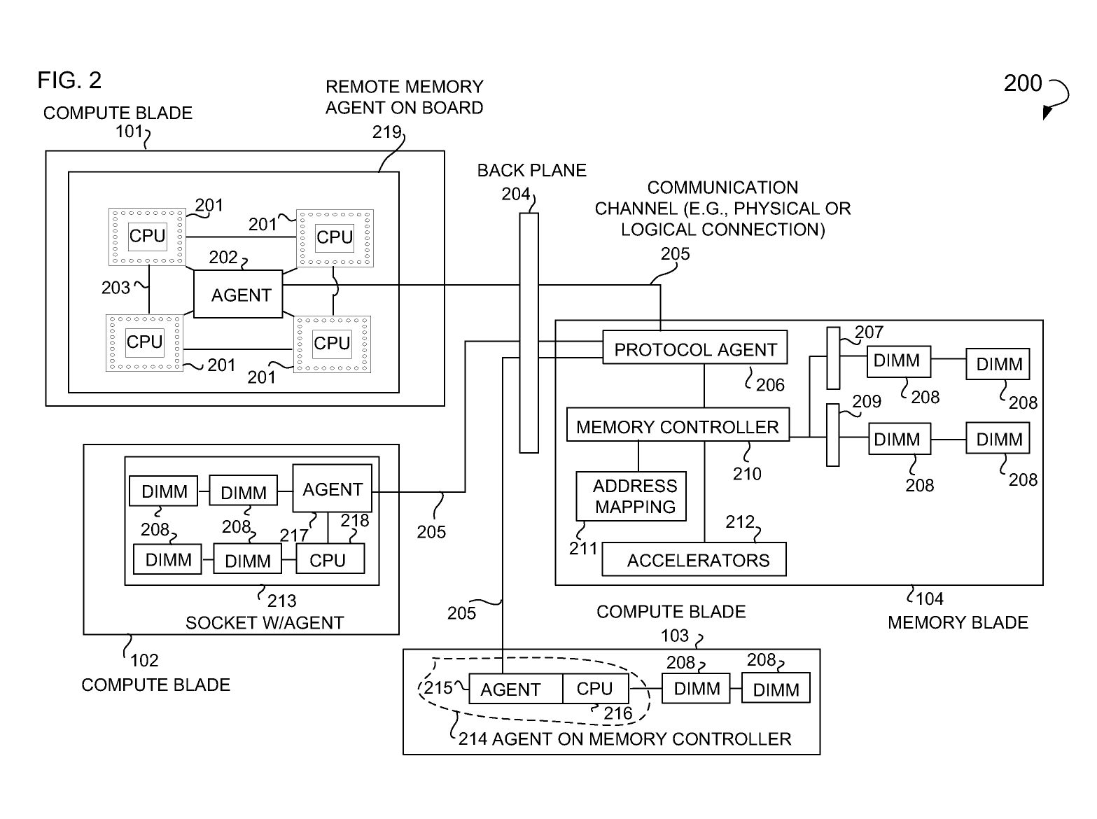

FIG. 2 is a diagram of an example system 200 that utilizes a memory agent to manage memory for a compute blade. Shown are the compute blade 101, the compute blade 102, and the compute blade 103, each of which is operatively connected to the memory blade 104 via a plurality of communication channels 205. In some example embodiments, the communication channel 205 is a logical or physical connection. Peripheral Component Interconnect Express (PCIe) is an example of the communication channels 205. Further, the communication channels 205 may be routed through a backplane 204 to operatively connect the various compute blades and memory blades. The compute blade 101 may include a remote memory agent on the motherboard of the compute blade 101. This remote memory agent on the motherboard of the compute blade 101 is referenced at 219. Further, shown is a plurality of Central Processing Unit (CPU) dies 201 operatively connected to one another via a plurality of point-to-point connections 203. These point-to-point connections 203 may include a coherent fabric such as a QUICKPATH INTERCONNECT™ (QPI). Additionally, shown is a memory agent 202 that is operatively connected to the plurality of CPU dies 201, and the connections may include QPI. The communication channel 205 operatively connects the memory agent 202 to the memory blade 104.

Additionally, shown is the compute blade 102 that includes a socket with a memory agent, referenced at 213. A socket, as used herein, is a CPU socket. The memory agent 217, includes as part of CPU socket, is referenced at 213. Operatively connected to the memory agent 217 is a CPU 218. Further, operatively connected to both the memory agent 217 and the CPU 218 is a plurality of memory modules 208. As with the memory agent 202, the memory agent 217 manages the traffic between the compute blade 102 and the memory blade 104 via a communication channel 205. Traffic includes memory commands such a read, and write commands.

Also shown is the compute blade 103 that illustrates a memory agent 215 as part of a memory controller that resides as a part of the CPU 216. Collectively, the memory agent 215 and CPU 216 are referenced at 214. As used herein, a memory controller is a digital circuit which manages the flow of data going to and from a memory module. The CPU 216 is operatively connected to memory modules 208. Like the memory agents 202 and 217, the memory agent 215 manages the traffic between the compute blade 103 and the memory blade 104.

In some example embodiments, a memory agent is implemented either as a separate chip on the compute blade board (see e.g., memory agent 202), or as zero-CPU chip sitting on a processor socket (see e.g., memory agent 217), or as part of the on-chip memory controller (see e.g., memory agent 215). The memory agent acts as the home node for data allocated on the memory blade(s) 104 or 105, and receives all cache coherency request for this data. The memory agent initiates and handles cache coherency protocols for request to this data, so no coherency supported is needed on the memory blade(s) 104 or 105. When a load/store is initiated to access the memory blade(s) 104 or 105, as indicated by its coherency request, the memory agent translates the request into a memory blade data access command (e.g., a memory command), which is transfer as a packet, for example, over the PCIe fabric. A cache coherency request, as used herein, is a request used in managing conflicts between caches used by one or more CPUs, and used in maintaining consistency between these caches and memory. In some example embodiments, the memory agent can have multiple PCIe lanes connecting to multiple memory blades to ensure maximum memory capacity. One memory blade can also be connected to multiple compute blades for capacity sharing. For example, memory blade 104 may be operative connected to memory blade 105.

The memory blade 104 is also shown that includes a number of modules. These modules may be hardware, software, of firmware. Additionally, these modules can include a protocol agent 206, memory controller 210, address mapping module 211, and accelerator module 212. The protocol agent manages memory commands received from the compute blades 101-103. For example, the protocol agent 201 communicates with the compute blades (e.g., compute blades 101 and 102). This communication may be via some type of protocol including PCIe, QPI, HYPERTRANSPORT™, or some other suitable protocol. Further, this communication includes the packing/unpacking of requests, commands and responses using the aforementioned protocols. Request that cannot be satisfied directly by the memory blade are forwarded to other memory blades or compute blades. A request forwarded to other memory blades is referenced herein as a memory-side request. A memory controller 210 is illustrated that handles read or write requests. In some example embodiments, these read and write requests are data pairs that include a bladelD, and a compute blade machine address (e.g., the SMA). An address mapping module 211 is implemented to check whether the read and write requests have the appropriate permissions. Where the appropriate permission exists, a requested access is permitted and a Remote Memory Address (RMMA) is retrieved by the address mapping module 211. The RMMA is forwarded by the memory controller 210 to a corresponding repeater buffer (e.g., buffer) 207 and 209 via a memory channel. The buffers 207 or 209 respond to this request through performing the necessary encoding and decoding operation for the memory modules 208 upon which the target data is located. These memory modules 208 may be Dual In-Line Memory Modules (DIMMS). Residing on the memory module 208 may be a virtual memory page. An accelerator module 212 is illustrated that can be implemented either within the memory controller 210, or a repeater buffers 207 and 209 to do special purpose computation on the data. This accelerator can be a CPU, special purpose processor, Application-Specific Integrated Circuit (ASIC), or a Field-Programmable Gate Array (FPGA). Special purpose computation includes the execution of hashing algorithms (e.g., the Secure Hashing Algorithm (SHA)), compression/decompression algorithms, encryption/decryption algorithms (e.g., the Advanced Encryption Standard (AES)), or Error Correction Coding (ECC)/chip kill coding. The buffers 207 or 209 may be implemented to hide the density/timing/control details of a memory module from the central memory controller. Further, a buffer may be used to independently operate other buffers in the case of the failure of another buffer.

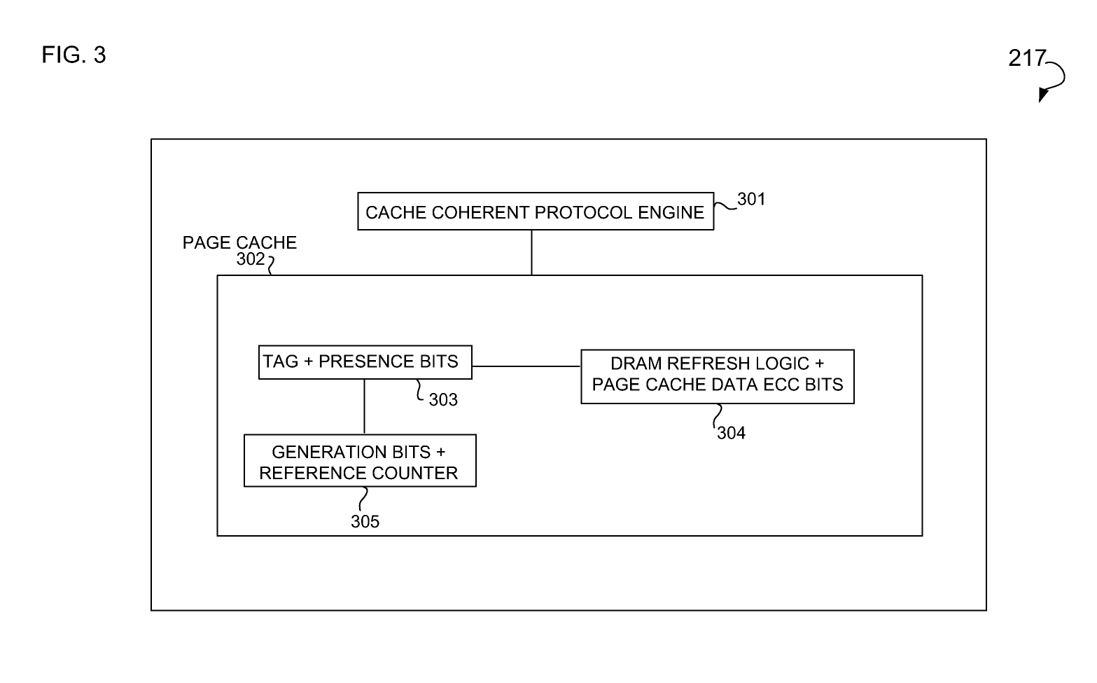

FIG. 3 is a diagram of example memory agent logic architecture resides part of the memory agent 202 or 217. This memory agent logic architecture may be implemented in software, firmware, or hardware. Shown is a cache coherence protocol engine 301 that processes memory commands received from the memory blade 104. This cache coherence protocol engine 301 is operatively connected to a page cache 302. Residing as a part of this page cache 302 is a grouping of tag and presence bits 303. The grouping of tagging and presence bits 303 may be organized to some type of suitable data structure including an array/vector, hash table, or other suitable data structure. Further, residing on the page cache 302 is a plurality of generation bits and reference counter bits that aggregate the generation bits. The generation bits and reference counter bits may be stored into some type of suitable data structure including an array/vector or hash table. A generation bit tracks a specific instance during which a virtual memory page is accessed. A generation is an example of an instance. The reference counter includes the number of accesses for data in a page stored in the page cache. Also stored on the page cache 302 is DRAM refresh logic and page cache ECC, collectively referenced at 304. The DRAM refresh logic includes circuit and instructions executed to refresh DRAM.

In some example embodiments, the cache coherent protocol engine 301 is implemented to handle incoming coherence requests. The cache coherent protocol engine 301 initiates and handles coherency transactions, and if no local copies in memory exists on any processor sockets, the cache coherent protocol engine 301 may source the data from either its page cache (e.g., that of the compute blades 101, 102, or 103) or the memory blade(s) 104 or 105. The coherence messages may be only sent to processor sockets. A write back request may either update its page cache or triggers a write command to the memory blades 104 or 105. A request to the memory blade(s) 104 or 105 is packetized via PCIe or other data format suitable for the connection between the compute blade and the memory blade, and the response from the memory blade(s) 104 or 105 also needs to be handled by the cache coherent protocol engine 301. Data may be stored into the page cache to speedup later accesses.

In some example embodiments, a memory agent implements the page cache tag array 303. The page cache tag array 303 may be implemented as part of the memory module 208 implemented as part of the memory agents 202, 215, or 217. The compute blade(s) 101-103 may have multiple agent chips or multiple agent sockets to further support more memory blade connections.

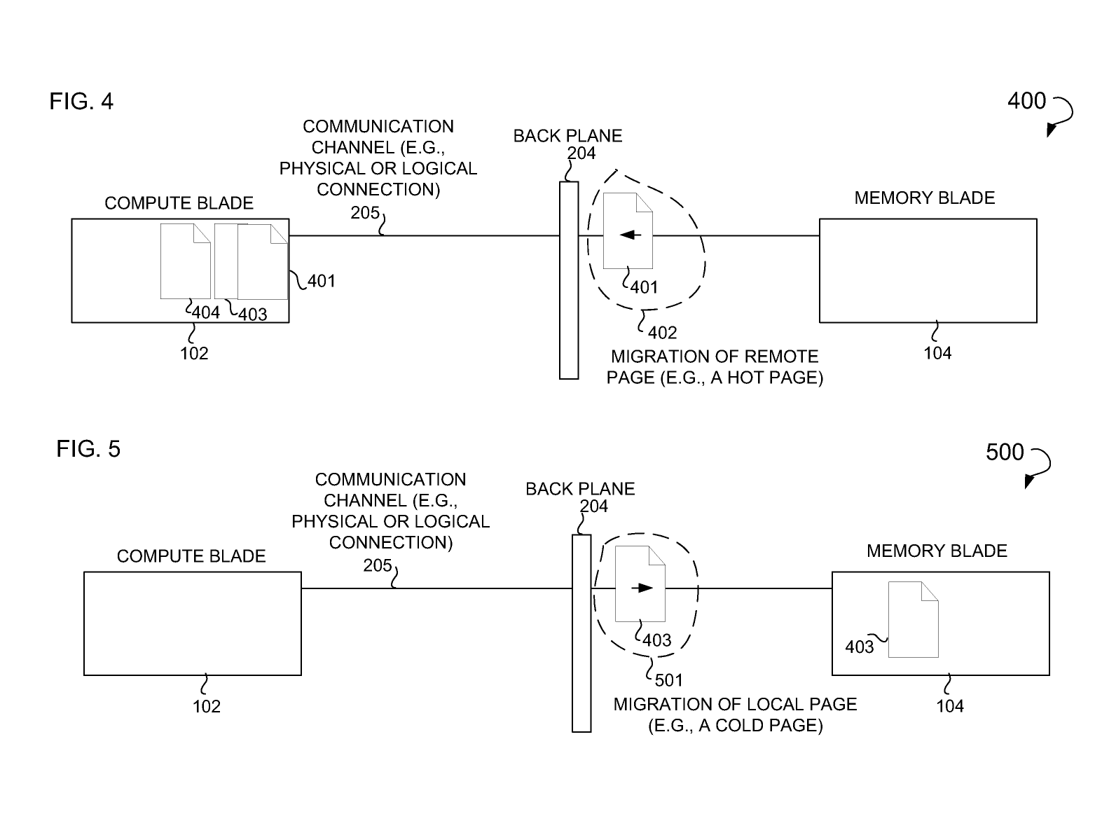

FIG. 4 is a diagram of an example system 400 illustrating the migration of a remote memory page. Illustrated is the compute blade 102 operatively coupled to the memory blade 104 via a communication channel 205. The communication channel 205 may be a logical or physical connection. Further, in some example embodiments, communication channel 205 passes through the backplane 204. The memory blade 104 transmits a virtual memory page 401 across the communication channel 205 to the compute blade 102 as part of the migration of the virtual memory page 401 referenced herein at 402. The virtual memory page 402 may be a hot page. The virtual memory page 401 is used to overwrite a victim page selected by the compute blade 102. Here, for example, virtual memory page 403, a local memory page, has been selected as a victim page. In some example embodiments, a temporary page, such as virtual memory page 404 is use to store the data of the victim page (e.g., virtual memory page 403).

FIG. 5 is a diagram of example system 500 illustrating the migration of a local memory page. Shown is the compute blade 102 that is operatively coupled to the memory blade 104 via the communication channel 205. Illustrated is the migration of the local virtual memory page 403 represented at 501. This local virtual memory page 403 may be a cold page. The virtual memory page 210 is transmitted across the communication channel 205 and received by the memory blade 104. This local virtual memory page 403 is used to over-write, for example, the previously remotely located virtual memory page 401. In some other example embodiments, other remotely located memory pages may be selected to be overwritten.

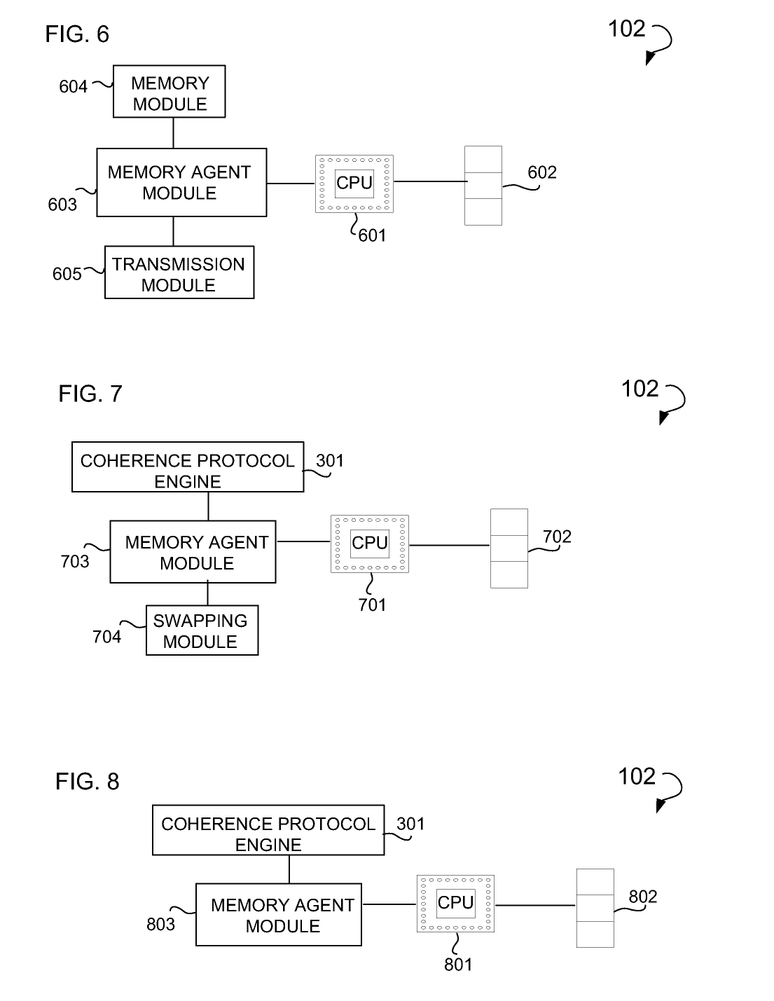

FIG. 6 is a block diagram of an example computer system in the form of the compute blade 102 used to implement a memory agent to process a memory command. These various blocks may be implemented in hardware, firmware, or software as part of the compute blade 101, compute blade 102, or compute blade 103. A CPU 601 is shown operatively connected to memory module 602. Operatively connected includes a logical or physical connection. Illustrated is a memory agent module 603 (e.g., a memory agent) to identify a memory command related to a virtual memory page associated with a memory blade. This memory agent module 603 is operatively connected to the CPU 601. Additionally shown, is a memory module 604, operatively connected to the memory agent module 603, which includes a page cache used by the memory agent to manage the virtual memory page. The memory module 604 may be DIMM or DRAM chips. A transmission module 605 is shown that is operatively connected to the memory agent module 603, the transmission module 605 to transmit the memory command to the memory blade. In some example embodiments, the memory command is transmitted if the command cannot be satisfied by data stored in the page cache. The memory agent module 603 may include at least one of the memory agent on a motherboard of the computer system, the memory agent populating a socket on the computer system, or the memory agent as part of a memory controller on the computer system. Further, the memory agent module 603 may include a cache coherence protocol engine, as well as logics, to filter out unnecessary access to the memory blade, and to update a generation bit and a reference counter value included in the page cache used by the memory agent. As used herein, unnecessary access is a memory command that is redundant relative to a prior or future memory command within a given time period. Additionally, unnecessary access, as used herein, means a memory command that seeks to access local memory such that a memory command need not be sent to a memory blade. Identify may include may include checking whether the target data address of the incoming request falls in the address range covered by memory blade. If so, the memory agent may perform a translation of a cache coherency request into the memory command. The memory command may include at least one of a read command, a write command, or a swap command. The swap command, as used herein, facilitates the execution of a page migration as outlined in FIGS. 4, 5, and 16. The page cache may include a prefetch buffer comprising the virtual memory page.

FIG. 7 is a block diagram of an example computer system in the form of the compute blade 102 used to implement a memory agent to maintain cache coherency. These various blocks may be implemented in hardware, firmware, or software as part of the compute blade 101, compute blade 102, or compute blade 103. A CPU 701 is shown operatively connected to memory module 702. Operatively connected includes a logical or physical connection. Illustrated is a memory agent module 703 that is operatively connected to the CPU 701. The memory agent module 703 is used to receive a coherency request that identifies data residing on a memory blade to be accessed. The memory agent module 703 translates the coherency request into a memory command formatted based upon a protocol utilized by the memory blade. Further, the memory agent module 703 transmits the memory command to the memory blade (e.g., the memory blade 105) to access the data residing on the memory blade. Additionally, the memory agent module 703 is used to update a reference counter value that identifies a total number of times a virtual memory page, which includes the data, is accessed. This updating may also be performed by the cache coherence protocol engine 301 that resides on or is operatively connected to the memory agent module 703. Moreover, the memory agent module 703 is used to set a generation bit that identifies an instance during which a virtual memory page, that includes the data, is accessed. This setting of the generation bit may also be performed by the cache coherence protocol engine 301 that resides on the memory agent module 703. In some example embodiments, the instance includes at least one of a number of CPU cycles, a memory command, or a clock time. The memory agent module 703 is used to respond to the coherency request through accessing local memory in lieu of accessing the memory blade. The memory agent module 703 may also be use to clear the generation bit after an expiration of a preset number of instances. Additionally, the memory agent module 703 may be used to identify a virtual memory page that includes the data based upon a reference counter value associated with the virtual memory page, the identifying based upon a comparison of the reference counter value to a further reference counter value associated with a further virtual memory page. A swapping module 704 may reside as part of the memory agent module, or be operatively connected to it, to swap or facilitate the migration of the virtual memory page with the further memory page based upon the comparison of the reference counter value to the further reference counter value associated with the further virtual memory page. In some example embodiments, memory command includes packetizing the memory command using a PCIe protocol.

FIG. 8 is a block diagram of an example computer system in the form of the compute blade 102 used to store data (e.g., evicted dirty data) to a write back buffer. These various blocks may be implemented in hardware, firmware, or software as part of the compute blade 101, compute blade 102, or compute blade 103. A CPU 801 is shown operatively connected to memory module 802. Operatively connected includes a logical or physical connection. Illustrated is a memory agent module 803 that is operatively connected to the CPU 801 to identify a virtual memory page, the virtual memory page identified based upon, in part, a reference counter value. The memory agent module 803 is also used to get data from the virtual memory page, the virtual memory page less frequently accessed than a further virtual memory page based upon a comparison of the reference counter value to a further reference counter value associated with the further virtual memory page. The comparison may be performed by the cache coherence protocol engine 301 that resides on or is operatively connected to the memory agent module 803. The memory agent module 803 may also be used to store the data into a write-back buffer. In some example embodiments, the reference counter value is stored in a page cache managed by the memory agent module 803. This page cache may be the page cache 302. Some example embodiment may include the write-back buffer is stored into a page cache such as page cache 302 that is managed by the memory agent module 803. The memory agent module 803 may also be used to write the data stored in the write-back buffer to a memory module managed by a memory blade such as memory blade 104. The memory module may be the memory module 208. In some example embodiments, at least one of the virtual memory page or the further virtual memory page are stored to a memory blade such as memory blade 104.

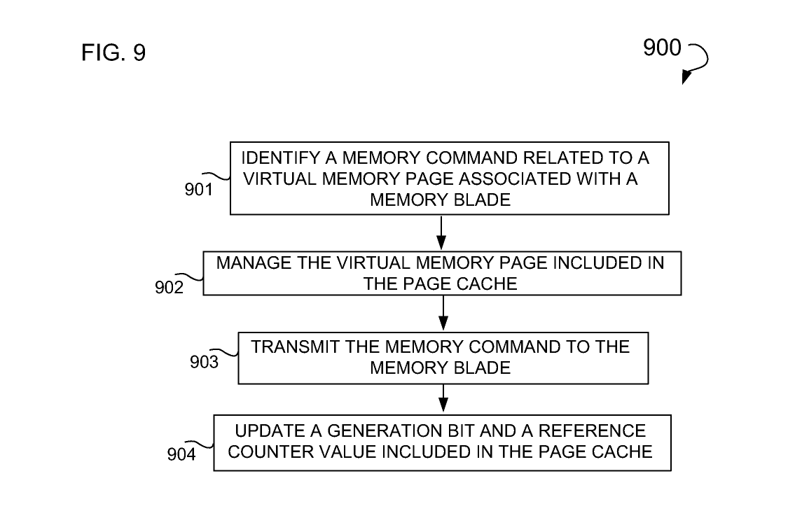

FIG. 9 is a flow chart illustrating an example method 900 executed on a compute blade to process a memory command. The compute blade may include the compute blade 101, the compute blade 102, or the compute blade 103. An operation 901 is executed by the memory agent module 603 to identify a memory command related to a virtual memory page associated with a memory blade. For other request received by the memory agent, for example, invalidating a piece of cached data, that should not involve the memory blade, the memory agent can directly respond on behalf of the memory blade to maintain cache coherency. Operation 902 is executed by the memory agent module 603 to manage the virtual memory page included in the page cache. Operation 903 is executed by the memory agent module 603 to transmit the memory command to the memory blade 105. Operation 904 is executed by the memory agent module 603 to update a generation bit and a reference counter value included in the page cache used by the memory agent module 603. In some example embodiments, identify may include checking whether the target data address of the incoming request falls in the address range covered by memory blade. If so, the memory agent may perform a translation of a cache coherency request into the memory command. In some example embodiments, the memory command includes at least one of a read command, a write command, or a swap command. In some example embodiments, the page cache includes a prefetch buffer comprising the virtual memory page.

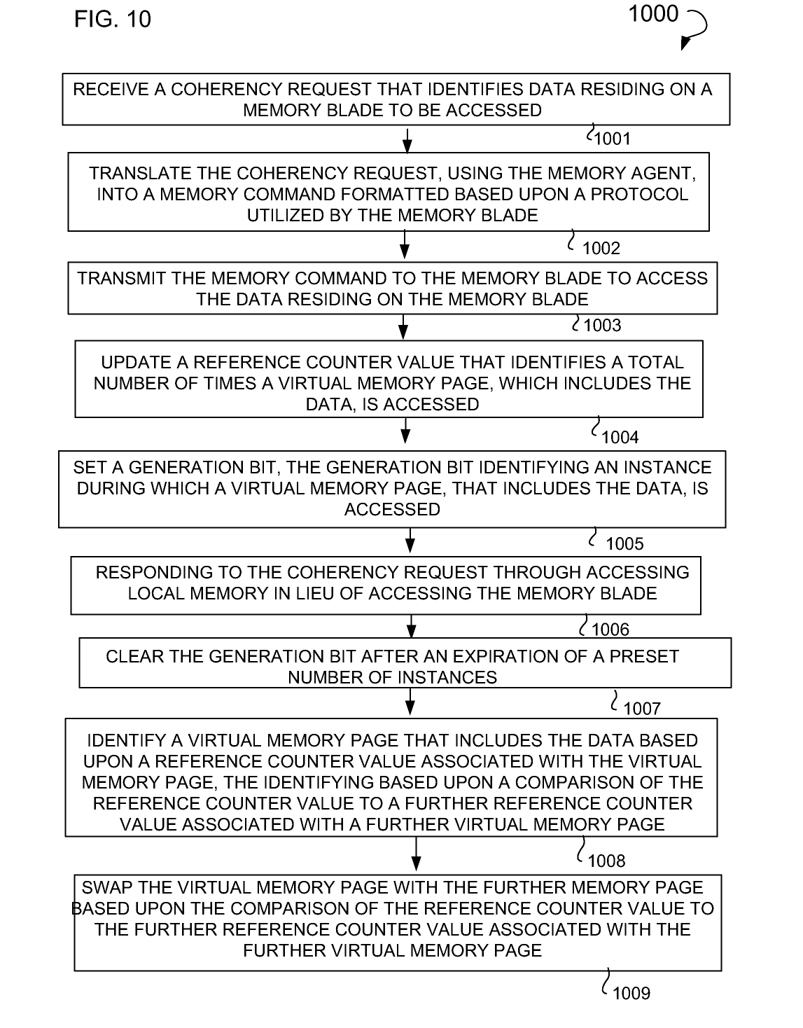

FIG. 10 is a flow chart illustrating an example method 1000 executed on a compute blade to implement a memory agent to maintain cache coherency. The compute blade may include the compute blade 101, the compute blade 102, or the compute blade 103. Operation 1001 is executed by the memory agent module 703 to receive a coherency request that identifies data residing on a memory blade to be accessed. Operation 1002 is executed by the memory agent module 703 to translate the coherency request, using the memory agent, into a memory command formatted based upon a protocol utilized by the memory blade. Operation 1003 is executed by the memory agent module 703 to transmit the memory command to the memory blade to access the data residing on the memory blade. Operation 1004 is executed by the memory agent module 703 to update a reference counter value that identifies a total number of times a virtual memory page, which includes the data, is accessed. Operation 1005 is executed by the memory agent module 703 to set a generation bit, the generation bit identifying an instance during which a virtual memory page, that includes the data, is accessed. In some example embodiments, the instance includes at least one of a number of CPU cycles, a memory command, or a clock time. Operation 1006 is executed by the memory management module 703 to respond to the coherency request through accessing local memory in lieu of accessing the memory blade. Operation 1007 is executed by the memory management module 703 to clear the generation bit after an expiration of a preset number of instances. Operation 1008 is executed by the memory agent module 703 to identify a virtual memory page that includes the data based upon a reference counter value associated with the virtual memory page, the identifying based upon a comparison of the reference counter value to a further reference counter value associated with a further virtual memory page. Operation 1009 is executed by the memory agent module 703 to swap the virtual memory page with the further memory page based upon the comparison of the reference counter value to the further reference counter value associated with the further virtual memory page (see e.g., FIGS. 4, 5, and 16 herein). In some example embodiments, the transmitting of the memory command includes packetizing the memory command using a PCIe protocol.

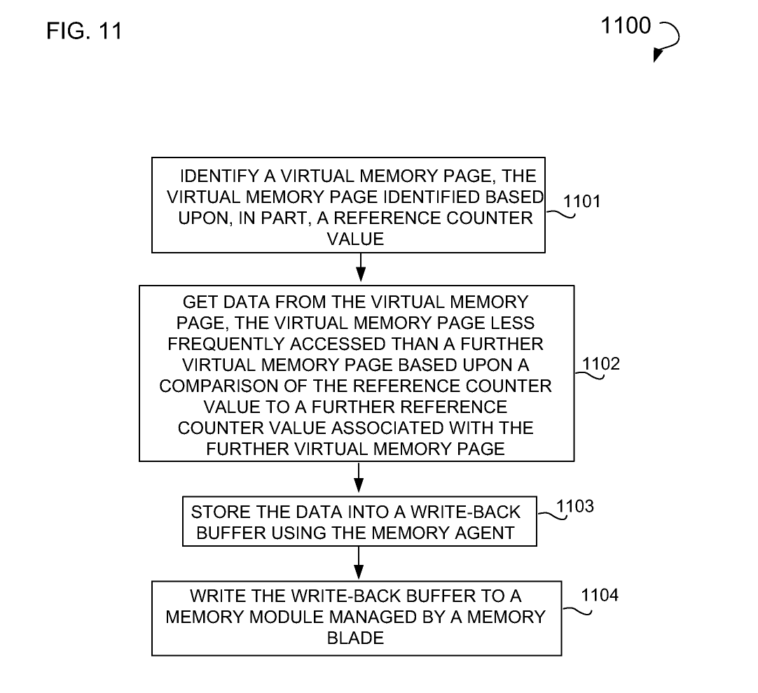

FIG. 11 is a flow chart illustrating an example method 1100 executed on a compute blade to store data to a write back buffer. The compute blade may include the compute blade 101, the compute blade 102, or the compute blade 103. Operation 1101 is executed by the memory agent module 803 to identify a virtual memory page, the virtual memory page identified based upon, in part, a reference counter value. Operation 1102 is executed by the memory agent module 803 to get data from the virtual memory page, the virtual memory page less frequently accessed than a further virtual memory page based upon a comparison of the reference counter value to a further reference counter value associated with the further virtual memory page. Operation 1103 is executed by the memory agent module 803 to store the data into a write-back buffer using the memory agent. In some example embodiments, the reference counter value is stored in a page cache managed by the memory agent. Further, in some example embodiments, the write-back buffer is stored in a page cache managed by the memory agent. Operation 1104 is executed by the memory agent module 803 to write the write-back buffer to a memory module managed by a memory blade. The memory module may include the memory module 208. In some example embodiments, at least one of the virtual memory page or the further virtual memory page are stored to a memory blade such as memory blade 104.

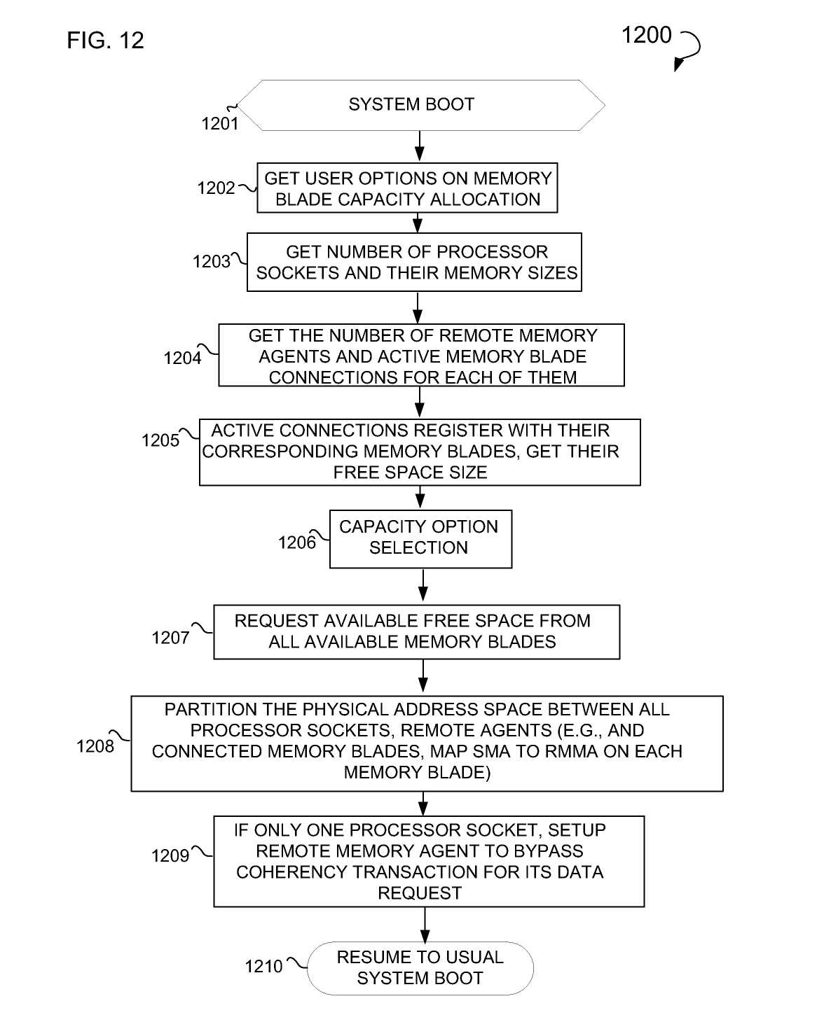

FIG. 12 is a flow chart illustrating an example method 1200 for initiating the boot up of a compute blade boot with memory agents. Illustrated are various operations 1201 through 1210 that are executed on the compute blade 101. An operation 1201 is executed to the conduct a system boot of the compute blade 101. An operation 1202 is executed to get user options regarding memory blade capacity allocation. Get, as referenced herein, includes identifying, retrieving, or some other suitable operation. These user options may be dictated by a Service Level Agreement (SLA) or boot options. An operation 1203 is executed to get the number of processors sockets and memory sizes associated with the compute blade upon which the method 1200 is executed (e.g., the compute blade 101). In some example embodiments, the execution of operation 1203 includes the retrieval of processor speed, bus speed, or other performance related information. Operation 1204 is executed to get the number of remote memory agents and active memory blade connections associated with each remote memory agents. An active memory blade connection may include the communication channel 205, an execution thread, or some other suitable connection. An operation 1205 is executed to register active memory blade connections with a corresponding memory blade to retrieve the free space size available on each memory blade. An operation 1206 is executed to conduct a capacity option selection as dictated by for example a service level agreement. This capacity option selection may include the memory capacity associated with the compute blade or the memory blade. An operation 1207 is executed to requests available speed free space from all available memory blades. An available memory blade is one that is operatively connected to the compute blade 101. An operation 1208 is executed to partition the physical address space between the processor sockets and remote agents. This partitioning may be based upon copying a SMA to a RMMA, and assigning an offset value to the RMMA. Furthermore, the memory agent records the address range covered by each active memory blade, which will be used to identify request associated with virtual pages stored or covered by memory blades. An operation 1209 is executed in cases where only one processor sockets exists on a compute blade. In such an example case, a bypass is implemented such that the coherency transaction is bypassed for the data request. A termination operation 1210 is executed to resume the usual system boot.

In some example embodiments, the SMA is used by the memory blade 104 to map to the RMMA. Specifically, a map register in the address mapping module 211 is indexed using a bladelD that uniquely identifies a memory blade, where each entry in the map register represents the number of super pages managed by the memory blade identified using the bladelD. Further, the base entry and a super page ID, parsed from the SMA, are used to index into an RMMA map. Each entry in the RMMA map that also resides on the address mapping module 211 represents a super page and the permissions associated with this super page. A super page is a virtual memory page of, for example, 16 KB or larger. A sub page is a virtual memory page that is, for example, smaller than 16 KB.

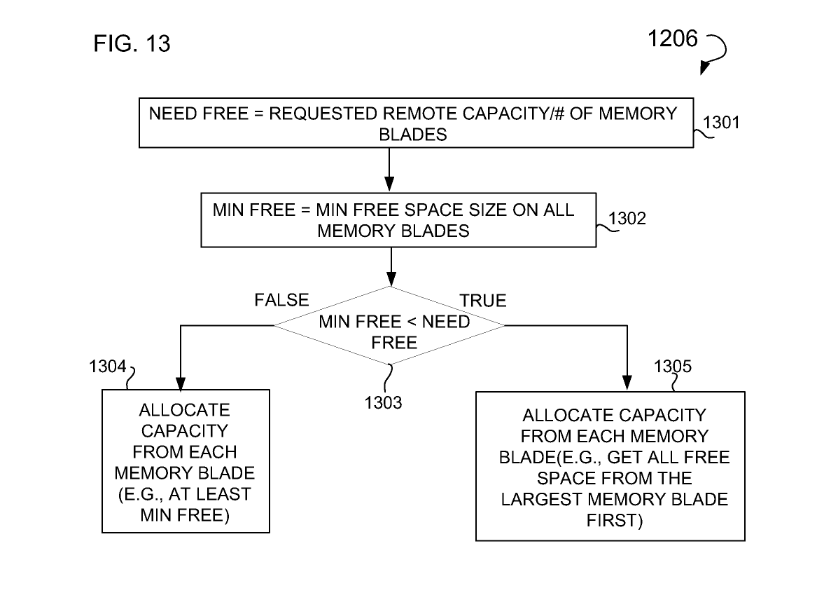

FIG. 13 is a flowchart illustrating the execution of an example operation 1206. The operation 1301 is executed to assign a value to a “need free” variable based upon finding the quotient of the requested remote memory capacity, divided by the number of memory blades. An operation 1302 is executed to assign a value to a “minimum free” variable based upon the minimum free space available on all memory blades to which the compute blade 101 is operatively connected. A decisional operation 1303 is shown that determines whether the “minimum free” variable is less than (<) the “need free” variable. In cases where decisional operation 1303 evaluates to “true” an operation 1305 is executed. In cases where decisional operation 1303 evaluates to “false” an operation 1304 is executed. The operation 1304, when executed, allocates capacity from each memory blade such that the minimum amount of free memory is allocated, this allocation defined by the “minimum free” variable. Operation 1305, when executed, allocates memory capacity from each memory blade such that capacity is initially allocated from that memory blade having the most amount of free memory. In some example embodiments, another suitable method is implemented, in lieu of operation 1305, to allocate free memory. This suitable method may include a memory allocation regime whereby memory is allocated equally from each memory blade to which the compute blade 101 is operatively connected.

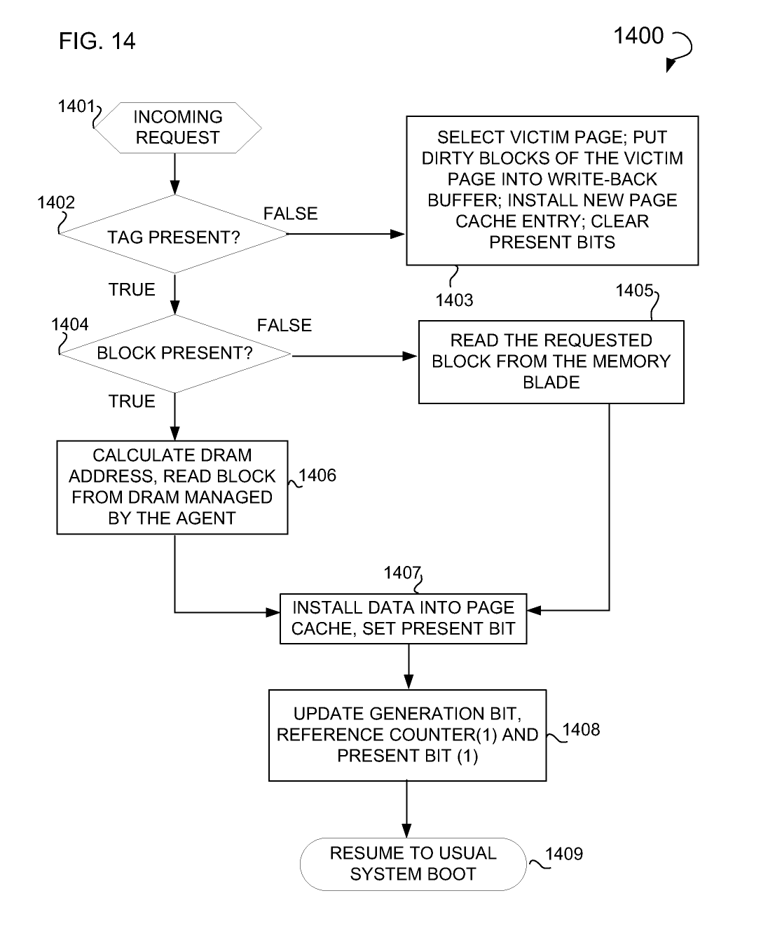

FIG. 14 is a flow chart illustrating an example method 1400 for page cache access. This method 1400 may be executed by a compute blade, such as the compute blade 101. Operation 1401 is executed to process an incoming memory requests. An incoming memory request may be a memory command such as a read or write command. A decisional operation 1402 is executed to determine whether this incoming request is for a virtual memory page that includes a tag denoting whether the requested virtual memory page is a “hot page” or a “cold page.” In example cases where the decisional operation 1401 evaluates to “false,” an operation 1403 is executed. In cases where decisional operation 1402 evaluates to “true,” a decisional operation 1404 is executed. Operation 1403, when executed, selects a victim page, puts the dirty blocks of the victim page into the write back buffer, installs a new page cache entry, and clears the presence bits. A victim page may be selected based upon a statistical value generated from the number of times the victim page is selected in one of more generations. Additionally, the dirty block of the victim page may be placed into the main memory of the compute blade in lieu of the write back buffer. Decisional operation 1404 determines whether a particular block of memory is present. In cases where decisional operation 1404 evaluates to “false,” operation 1405 is executed. In cases where decisional operation 1404 evaluates to “true,” operation 1406 is executed. Operation 1405, when executed, reads the requested block from the memory blade 104. In cases where operation 1405 successfully executes the operation 1407 is executed. Operation 1406, when executed, calculates the DRAM address, and reads the block from the DRAM managed by the memory agent. Operation 1407 is executed to install data into a page cache, and to set the present bit. The present bit denotes the corresponding block within the virtual memory page as being installed in the page cache. Operation 1408 is executed to update the generation bit value, the reference counter and present bit. The execution of operation 1407 may be facilitated by the memory agent 217 to reflect the swapping of the remote and local memory pages. A termination operation 1409 is executed to resume the usual system boot associated with the memory blade 101.

In some example embodiments, data is sourced from the page cache of the compute blade 101 and hence can avoid sending a request to the memory blade 104. The page cache maintains cache tag arrays in SRAM for fast access, and stores the data array DRAM). The organization of the tag array may be similar to the processor cache except that each cache entry corresponds to a 4K virtual memory page, instead of a typical 64-byte cache block. A block presence vector may be used to record what blocks are currently present and valid in the page cache. Accesses to non-present blocks trigger memory blade reads, and page cache eviction triggers memory blade writes for dirty blocks.

Some example embodiments include cache block prefetching that can be integrated into the page cache. This integration can be performed either with a small prefetch buffer tagged at cache block granularity, or directly into the page cache. Similar to processor cache, various prefetching policies can be used to partially or completely hide remote memory access latency, if a cache block is fetched from the memory blade before it is requested. One simple policy is next-N block prefetch, which prefetches the next-N blocks whenever there is a page cache miss. To facilitate the selection of a victim page, and to promote page migration (see e.g., FIGS. 4 and 5), the page cache maintains per-page access statistics. These statics may relate to (1) access recency information for generational replacement, and (2) access frequency information for page promotion. Such statistical information may be grouped into separate arrays and kept in the page cache SRAM for fast access.

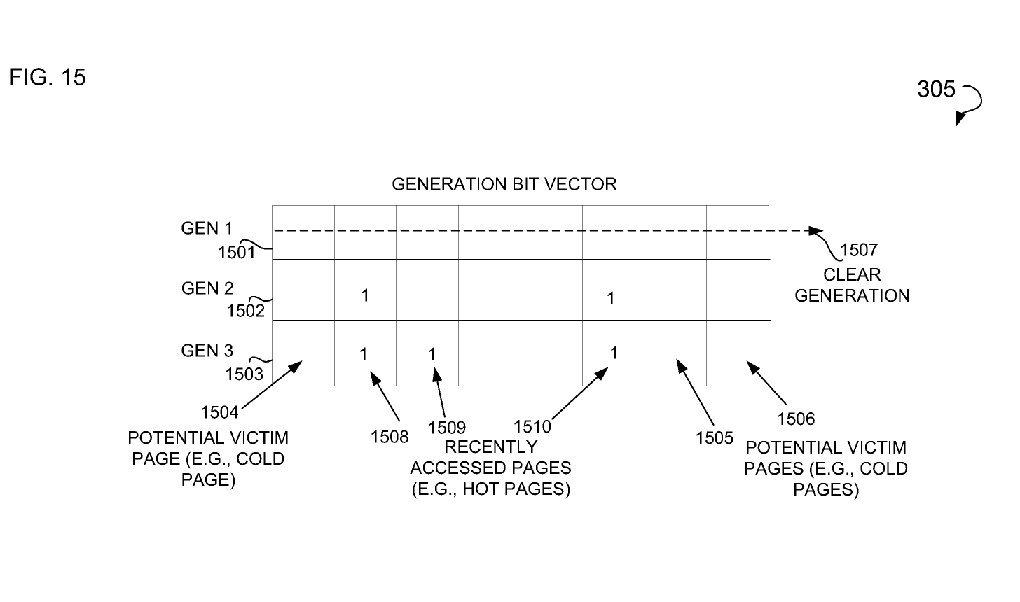

FIG. 15 is a diagram of an example vector storing the generation bits and reference counter values as part of a page cache. Shown, for example, are a generation one row 1501, a generation two row 1502, and a generation three row 1503. A generation row is a row in a vector that denoting a virtual memory page has been accessed in the corresponding generation. A generation may be a number of CPU cycles, a number of memory commands, a number of clock times, or some other suitable period of time or occurrence of an event. Each column in the vector represents a particular virtual memory page. In some example embodiments, a generation row (e.g., generation one row 1501) is cleared as denoted at 1507. A row may be cleared based upon a present number of generations as denoted in an SLA. As reflected in generation row two 1502 each time a virtual memory page in accessed a bit is flipped to denote the accessing of the virtual memory page. In generation row two 1502 two virtual memory pages have been accessed. Generation row three 1503 reflects the reference counter value that aggregates the number of times the virtual memory page has been accessed across a certain number of generations. This reference counter value may be used to determine a “hot page,” a “cold page,” or a victim page. A particular virtual memory page that has not been accessed within a predetermined number of generations (e.g., two generations) may be referred to as a “cold page” and also may be a victim page. A “cold page” may be identified as a victim page and later swapped (see e.g., FIGS. 4 and 5). Potential victim pages are referenced at 1504-1506. Also shown are “hot pages” that have been recently accessed and may not be identified for swapping. “Hot pages” are referenced at 1508-1510 and are denoted in the vector by the bit value “1.” Virtual memory pages that are “hot pages” may be tagged as such in the memory cache 305. A tag may be a bit value or collection of bits values identifying a virtual memory page as recently accessed as defined by the generation.

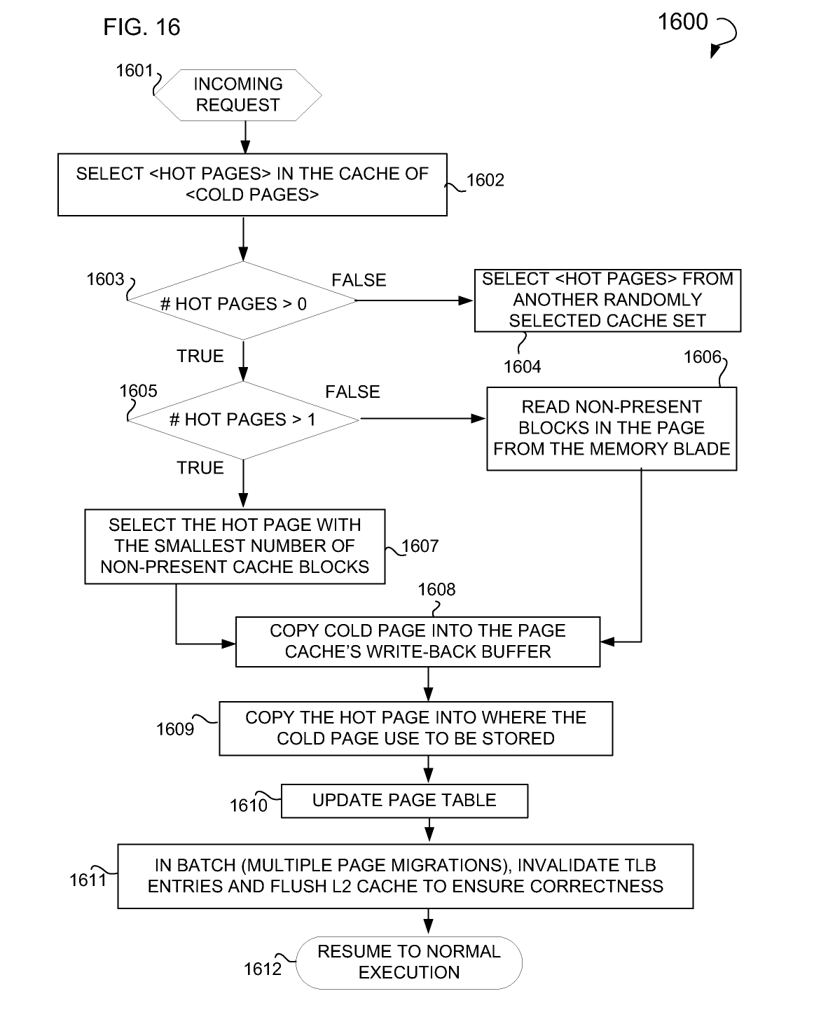

FIG. 16 is a flow chart illustrating an example method 1600 used to facilitate page migration. Shown is a process 1601 that processes incoming requests, where these incoming requests are a memory command related to migrating hot remote pages to local memory. Operation 1602 is executed to select a virtual memory page is that tagged as a “hot page.” A decisional operation 1603 is illustrated that determines whether the number of hot pages is greater than 0. In cases where decisional operation 1603 evaluates to “false,” an operation 1604 is executed. In cases where decisional operation 1603 evaluates to “true,” a decisional operation 1605 is executed. Operation 1604 is executed to select “hot pages” from another randomly selected cache sat. Decisional operation 1605 determines whether the number of “hot pages” is greater than one. In example cases where decisional operation 1605 evaluates to “false,” operation 1606 is executed. In cases where decisional operation 1605 evaluates to “true,” an operation 1607 is executed. Operation 1606, when executed, reads non-present blocks into the virtual memory page from the memory blade. Operation 1607, when executed, selects a “hot page” with the smallest number of non-present cache blocks. An operation 1608 is executed upon the completion of the operation 1606 and 1607. The operation 1608, when executed, copies the “cold page” into the page cache's write back buffer. An operation 1609 is executed to copy the “hot page” into where the “cold page” was previously stored. Operation 1610 is executed update page table of the compute blade. Operation 1611 is executed to, in batch, invalidate TLB entries, and flush the Level 2 (L2) cache to ensure correctness. Operation 1612 is executed to resume normal execution of the compute blade.

In some example embodiment, the page cache, which not only stores the recently used virtual memory pages and blocks, also provides recency information (e.g., access generation bits) and page-level access frequency information for promotion page selection. Further, the page cache also provides the write back buffers for temporarily storing demoted local pages. In some example cases, when page migration is initiated (see e.g., FIG. 5) it can request for a number of hot pages from the page cache. Such hot pages can be selected from a hot page vector. The hot page vector includes the highest bits of the reference counters. Both generation bits and reference counters may be periodically cleared such that: the older generation bits are cleared and used to record recent generation access information; the lower-bits of the reference counters are cleared and higher bits are rotated into lower bits to keep track of history information. In some embodiments, the generation bits are used for victim page selection. The selection logic chooses the victim pages within a cache set and selects the first page that has not been accessed in the more recent generation. This selection may be accomplished through AND'ing these bits. A first-zero logic may be used to select such a page.

In some example embodiments, the method 1600 is executed to select cold pages from the local memory to be replaced using reference history information (e.g., available in page table access bits as illustrated in FIG. 15). The method 1600 is executed to identify “hot pages,” “cold pages,” and swap each pair of “cold” and “hot” pages. The swapping includes the swapping of both page content and address mapping/re-mapping. The processor Translation Lookaside Buffer (TLB) is refreshed (e.g., a TLB shootdown is implemented), potentially in batch, to reflect such address mapping changes. The non-present blocks in each “hot page” are read from the memory blade before the swapping and the “cold page” can also be temporarily stored in page cache and gradually written-back to the memory blade. In some example embodiments, the memory blade may restrict a page being migrated into a compute blade's local memory if this page is read-only shared among multiple compute blades at this time. Read only information and the number of compute blades accessing the page is recorded in the page cache, and used to avoid the selection of such hot-pages for migration.

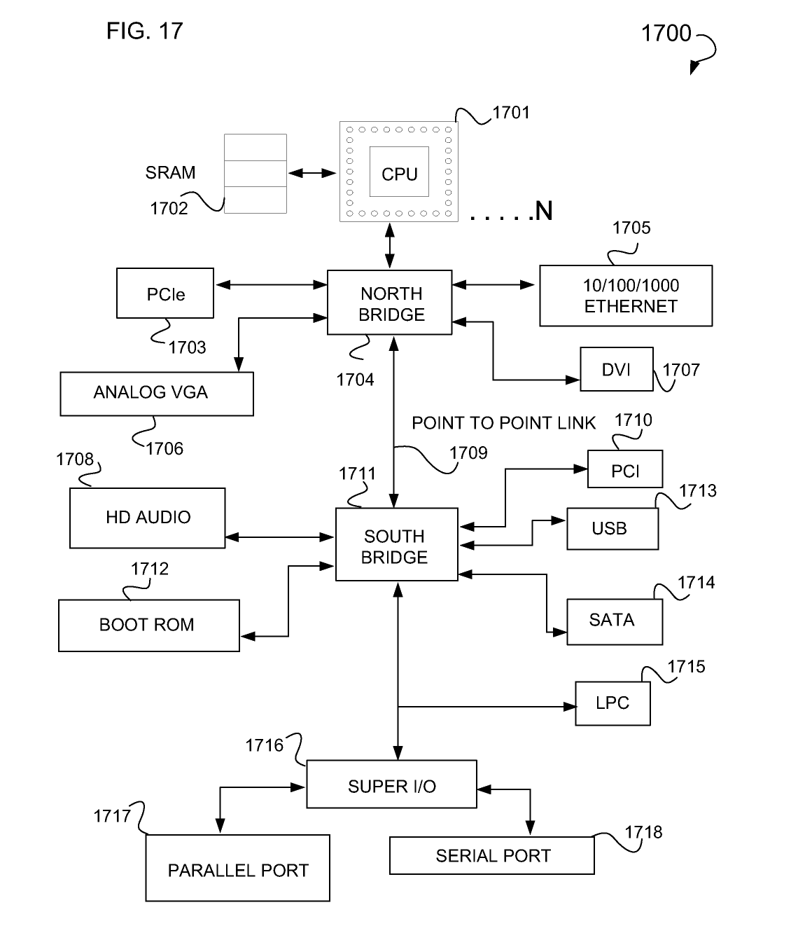

FIG. 17 is a diagram of an example computer system 1700. Shown is a CPU 1701. The processor die 201 may be a CPU 1701. In some example embodiments, a plurality of CPU may be implemented on the computer system 1700 in the form of a plurality of core (e.g., a multi-core computer system), or in some other suitable configuration. Some example CPUs include the x86 series CPU. Operatively connected to the CPU 1701 is SRAM 1702. Operatively connected includes a physical or logical connection such as, for example, a point to point connection, an optical connection, a bus connection or some other suitable connection. A North Bridge 1704 is shown, also known as a Memory Controller Hub (MCH), or an Integrated Memory Controller (IMC), that handles communication between the CPU and PCIe, DRAM, and the South Bridge. A PCIe port 1703 is shown that provides a computer expansion port for connection to graphics cards and associated Graphical Processing Units (GPUs). An ethernet port 1705 is shown that is operatively connected to the North Bridge 1704. A Digital Visual Interface (DVI) port 1707 is shown that is operatively connected to the North Bridge 1704. Additionally, an analog Video Graphics Array (VGA) port 1706 is shown that is operatively connected to the North Bridge 1704. Connecting the North Bridge 1704 and the South Bridge 1711 is a point to point link 1709. In some example embodiments, the point to point link 1709 is replaced with one of the above referenced physical or logical connections. A South Bridge 1711, also known as an I/O Controller Hub (ICH) or a Platform Controller Hub (PCH), is also illustrated. Operatively connected to the South Bridge 1711 is a High Definition (HD) audio port 1708, boot RAM port 1712, PCI port 1710, Universal Serial Bus (USB) port 1713, a port for a Serial Advanced Technology Attachment (SATA) 1714, and a port for a Low Pin Count (LCP) bus 1715. Operatively connected to the South Bridge 1711 is a Super Input/Output (I/O) controller 1716 to provide an interface for low-bandwidth devices (e.g., keyboard, mouse, serial ports, parallel ports, disk controllers). Operatively connected to the Super I/O controller 1716 is a parallel port 1717, and a serial port 1718.

The SATA port 1714 may interface with a persistent storage medium (e.g., an optical storage devices, or magnetic storage device) that includes a machine-readable medium on which is stored one or more sets of instructions and data structures (e.g., software) embodying or utilized by any one or more of the methodologies or functions illustrated herein. The software may also reside, completely or at least partially, within the SRAM 1702 and/or within the CPU 1701 during execution thereof by the computer system 1700. The instructions may further be transmitted or received over the 10/100/1000 ethernet port 1705, USB port 1713 or some other suitable port illustrated herein.

In some example embodiments, a removable physical storage medium is shown to be a single medium, and the term “machine-readable medium” should be taken to include a single medium or multiple medium (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any of the one or more of the methodologies illustrated herein. The term “machine-readable medium” shall accordingly be taken to include, but not be limited to, solid-state memories, optical and magnetic medium, and carrier wave signals.

Data and instructions (of the software) are stored in respective storage devices, which are implemented as one or more computer-readable or computer-usable storage media or mediums. The storage media include different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; and optical media such as Compact Disks (CDs) or Digital Versatile Disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the “true” spirit and scope of the invention.

What is claimed is:

1. A computer system comprising:
a memory agent module to identify a memory command related to a virtual memory page associated with a memory blade;
a memory module, operatively connected to the memory agent, that includes a page cache used by the memory agent to manage the virtual memory page; and
a transmission module to transmit the memory command to the memory blade.

2. The computer system of claim 1, wherein the memory agent includes at least one of the memory agent on a motherboard of the computer system, the memory agent as part of a socket on the computer system, or the memory agent as part of a memory controller on the computer system.

3. The computer system of claim 1, wherein the memory agent includes a cache coherence protocol engine to filter out unnecessary access to the memory blade, and to update a generation bit and a reference counter value included in the page cache used by the memory agent.

4. The computer system of claim 1, wherein to identify includes a translation of a cache coherency request into the memory command to the memory blade.

5. The computer system of claim 1, wherein the memory command includes at least one of a read command, a write command, or a swap command.

6. A computer implemented method comprising:
receiving a coherency request, using a memory agent, that identifies data residing on a memory blade to be accessed;
translating the coherency request, using the memory agent, into a memory command formatted based upon a protocol utilized by the memory blade; and
transmitting the memory command, using the memory agent, to the memory blade to access the data residing on the memory blade.

7. The computer implemented method of claim 6, further comprising updating a reference counter value, using the memory agent, that identifies a total number of times a virtual memory page, that includes the data, is accessed.

8. The computer implemented method of claim 6, further comprising setting a generation bit, using the memory agent, the generation bit identifying an instance during which a virtual memory page, that includes the data, is accessed.

9. The computer implemented method of claim 6, further comprising responding to the coherency request through accessing local memory in lieu of accessing the memory blade.

10. The computer implemented method of claim 6, further comprising clearing a generation bit, using the memory agent, after an expiration of a preset number of instances.

11. The computer implemented method of claim 6, further comprising identifying, using the memory agent, a virtual memory page that includes the data based upon a reference counter value associated with the virtual memory page, the identifying based upon a comparison of the reference counter value to a further reference counter value associated with a further virtual memory page.

12. The computer implemented method of claim 11, further comprising swapping the virtual memory page with the further memory page based upon the comparison of the reference counter value to the further reference counter value associated with the further virtual memory page.

13. The computer implemented method of claim 6, wherein the transmitting of the memory command includes packetizing the memory command using a Peripheral Component Interconnect Express (PCIe) protocol, Quick Path Interconnect (QPI), or a HyperTransport protocol.

14. A computer implemented method comprising:
identifying a virtual memory page, using a memory agent, the virtual memory page identified based upon, in part, a reference counter value;
getting data from the virtual memory page, using the memory agent, the virtual memory page less frequently accessed than a further virtual memory page based upon a comparison of the reference counter value to a further reference counter value associated with the further virtual memory page; and
storing the data into a write-back buffer using the memory agent.

15. The computer implemented method of claim 14, further comprising writing the write-back buffer to a memory module, using the memory agent, managed by a memory blade.
